(19) United States
(12) Patent Application Publication
(10) Pub. No.: US 2007/0253480 A1
(43) Pub. Date: Nov. 1, 2007

(54) Encoding method, encoding apparatus, and computer program

(75) Inventors: Satoshi Tsujii, Tokyo (JP); Hiroshi Jinno, Kanagawa (JP); Keiji Kanota, Kanagawa (JP); Makoto Yamada, Tokyo (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 11/789,937

(22) Filed: Apr. 25, 2007

(30) Foreign Application Priority Data
Apr. 26, 2006 (JP) P2006-122136

(51) Int. Cl. H04N 7/12

(52) U.S. Cl. 375/240.08; 375/240.26

(57) ABSTRACT

An encoding apparatus includes a processing unit for generating and/or processing a moving image, an encoding unit for encoding one of the generated moving image and the processed moving image, and a control unit for controlling the encoding unit so that an amount of code per predetermined unit encoded by the encoding unit corresponds to information supplied from the processing unit, the information indicating one of the status of the moving image, the status of generation of the moving image, and a process of the processing unit applied to the moving image.

### CROSS REFERENCES TO RELATED APPLICATIONS

The present invention contains subject matter related to Japanese Patent Application JP 2006-122136 filed in the Japanese Patent Office on Apr. 26, 2006, the entire contents of which are incorporated herein by reference.

### BACKGROUND OF THE INVENTION

1. Field of the Invention

The present invention relates to an encoding method, an encoding apparatus, and a computer program and, in particular, to an encoding method, an encoding apparatus, and a computer program for encoding a moving object.

2. Description of the Related Art

Compression encoding techniques are widely used to encode images with a smaller amount of data involved. In the known compression encoding technique for encoding a moving image photographed by a camera, a compression encoder or a pre-process filter arranged in the compression encoder extracts a feature from the moving image, determines the degree of difficulty of encoding, and controls an amount of code generated as a result of encoding based on the determined degree of difficulty.

Japanese Unexamined Patent Application Publication No. 2002-369142 discloses a technique in which a microcomputer for controlling target information amount controls a compression encoder according to a target bit rate. According to the disclosure, a predetermined compression encoding process is performed on moving image data from a filter processor arranged in a front-end stage of the compression encoder to organize an encoded bit stream. A filter coefficient is supplied to the filter processor to convert the moving image data into data having a definition appropriate for encoding.

### SUMMARY OF THE INVENTION

The feature of the image is extracted by the compression encoder in the known art. To know the feature of a future image frame in advance with the feature of the image successively changing, a large capacity memory is required. A large number of frames of image is stored, and the feature of the image is extracted before being actually compression encoded.

It is desirable to encode an image without using a large capacity memory.

In accordance with one embodiment of the present invention, an encoding apparatus includes a processing unit for generating and/or processing a moving image, an encoding unit for encoding one of the generated moving image and the processed moving image, and a control unit for controlling the encoding unit so that an amount of code per predetermined unit encoded by the encoding unit corresponds to information supplied from the processing unit, the information indicating one of the status of the moving image, the status of generation of the moving image, and a process of the processing unit applied to the moving image.

The control unit may control the encoding unit so that the amount of code per predetermined unit corresponds to the information supplied from the processing unit, the information indicating one of the status of a frame forming the moving image, the status of generation of the frame, and the process applied to the frame.

The control unit may control the encoding unit so that the amount of code per encoding unit area corresponds to the information, the encoding unit area including a predetermined number of pixels in a frame forming the moving image.

The control unit may control the encoding unit so that an amount of code per macro block corresponds to the information by introducing a Q scale in the encoding of the macro block as the encoding unit area.

The encoding apparatus may further include an introducing unit for introducing an amount of code per group of pictures (GOP) in response to the information indicating one of the status of the moving image, the status of generation of the moving image, and the process applied to the moving image. The control unit may control the encoding unit so that an amount of code per macro block varies in response to the information with respect to the amount of code per introduced GOP, the macro block being the unit.

The control unit may control the encoding unit so that the amount of code per unit to be encoded by the encoding unit from now on corresponds to the information and the amount of code encoded so far by the encoding unit.

The processing unit may generate the moving image by photographing a subject.

The processing unit may process the moving image to detect an image of a face contained in the moving image, and the control unit may control the encoding unit so that the amount of code per unit corresponds to the image of the detected face.

In accordance with one embodiment of the present invention, an encoding method of an encoding apparatus including processing unit for generating and/or processing a moving image and encoding unit for encoding one of the generated moving image and the processed moving image, includes a step of controlling the encoding unit so that an amount of code per predetermined unit encoded by the encoding unit corresponds to information supplied from the processing unit, the information indicating one of the status of the moving image, the status of generation of the moving image, and a process of the processing unit applied to the moving image.

In accordance with one embodiment of the present invention, a computer program for causing a computer to perform an encoding method of an encoding apparatus including processing unit for generating and/or processing a moving image and encoding unit for encoding one of the generated moving image and the processed moving image, includes a step of controlling the encoding unit so that an amount of code per predetermined unit encoded by the encoding unit corresponds to information supplied from the processing unit, the information indicating one of the status of the moving image, the status of generation of the moving image, and a process of the processing unit applied to the moving image.

In accordance with embodiments of the present invention, the moving image is generated and/or processed. One of the generated moving image and the processed moving image is encoded. The encoding of the moving image is controlled so that the amount of code per predetermined unit encoded by the encoding unit corresponds to the information supplied from the processing unit, the information being generated in the generation of the moving image or the process of the moving image and indicating one of the status of the moving image, the status of generation of the moving image, and the process applied to the moving image.

In accordance with embodiments of the present invention, the encoding of the moving image is controlled so that the amount of code per predetermined unit encoded by the encoding unit corresponds to the information supplied from the processing unit, the information indicating one of the status of the moving image, the status of generation of the moving image, and a process applied to the moving image.

In accordance with embodiments of the present invention, the moving image is encoded.

In accordance with embodiments of the present invention, the image is encoded without the need for a large capacity memory.

### BRIEF DESCRIPTION OF THE DRAWINGS

FIG. 1 is a block diagram of an encoding apparatus in accordance with one embodiment of the present invention;

FIG. 2 illustrates a specific example of imaging information, image processing information, rate control information, quantization information, and quantization instruction information in accordance with one embodiment of the present invention;

FIG. 3 illustrates a specific example of the imaging information, the image processing information, the rate control information, the quantization information, and the quantization instruction information in accordance with one embodiment of the present invention;

FIG. 4 is a block diagram illustrating an imaging unit in accordance with one embodiment of the present invention;

FIG. 5 is a block diagram illustrating an image processor in accordance with one embodiment of the present invention;

FIG. 6 is a block diagram illustrating an image compressor in accordance with one embodiment of the present invention;

FIG. 7 illustrates time difference between time of acquisition of one of the imaging information and the image processing information relating to a frame and time of encoding of that frame in accordance with one embodiment of the present invention;

FIGS. 8A-8D illustrate an example of quantization tables in accordance with one embodiment of the present invention;

FIGS. 9A-9E illustrate an example of rate tables in accordance with one embodiment of the present invention;

FIG. 10A-10C illustrate an example of an imaging information table and an image processing information table in accordance with one embodiment of the present invention;

FIG. 11 illustrates a face macro block identification table in accordance with one embodiment of the present invention;

FIG. 12 illustrates a summary of process from detecting a face image to storing a macro block number in the face macro block identification table in accordance with one embodiment of the present invention;

FIG. 13 illustrates a summary of process from detecting the imaging information to storing a camera motion vector in a motion vector table in accordance with one embodiment of the present invention;

FIG. 14 illustrates a summary of process from detecting the image processing information to storing an effect ID in an effect table to storing a filter ID in a filter table in accordance with one embodiment of the present invention;

FIG. 15 is a flowchart illustrating of an input process in accordance with one embodiment of the present invention;

FIG. 16 is a flowchart illustrating a GOP bit rate setting process in accordance with one embodiment of the present invention;

FIG. 17 is a flowchart illustrating a transfer process of the imaging information in accordance with one embodiment of the present invention;

FIG. 18 is a flowchart illustrating a transfer process of the image processing information in accordance with one embodiment of the present invention;

FIG. 19 is a flowchart illustrating an identification process of a macro block number of a macro block of the face image in accordance with one embodiment of the present invention;

FIG. 20 is a flowchart illustrating a Q scale setting process in accordance with one embodiment of the present invention;

FIG. 21 is a flowchart illustrating a Q scale correction process in accordance with one embodiment of the present invention;

FIG. 22 is a continuation of the flowchart of FIG. 21;

FIG. 23 is a flowchart illustrating a storage process of the quantization information in accordance with one embodiment of the present invention;

FIG. 24 is a flowchart illustrating a rate instruction process in accordance with one embodiment of the present invention; and

FIG. 25 is a flowchart illustrating a rate control process in accordance with one embodiment of the present invention.

### DESCRIPTION OF THE PREFERRED EMBODIMENTS

Before describing an embodiment of the present invention, the correspondence between the features of the present invention and an embodiment disclosed in the specification or the drawings of the invention is discussed below. This statement is intended to assure that embodiments supporting the claimed invention are described in this specification or the drawings. Thus, even if an embodiment is described in the specification or the drawings, but not described as relating to a feature of the invention herein, that does not necessarily mean that the embodiment does not relate to that feature of the invention. Conversely, even if an embodiment is described herein as relating to a certain feature of the invention, that does not necessarily mean that the embodiment does not relate to other features of the invention.

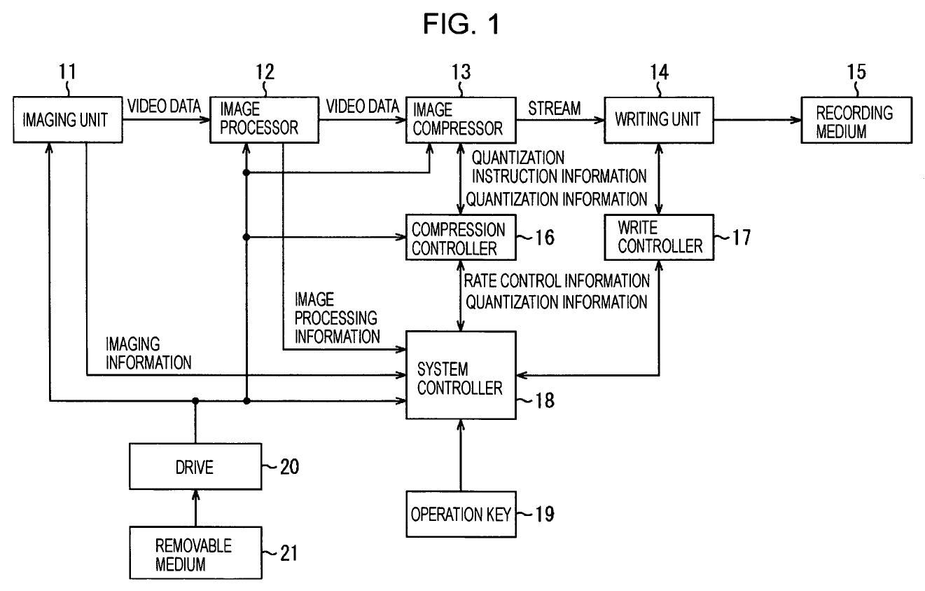

In accordance with one embodiment of the present invention, an encoding apparatus includes a processing unit (for example, image processor 12 of FIG. 1) for generating and/or processing a moving image, an encoding unit (for example, image compressor 13 of FIG. 1) for encoding one of the generated moving image and the processed moving image, and a control unit (for example, compression controller 16 of FIG. 1) for controlling the encoding unit so that an amount of code per predetermined unit encoded by the encoding unit corresponds to information supplied from the processing unit, the information indicating one of the status of the moving image, the status of generation of the moving image, and a process of the processing unit applied to the moving image.

The encoding apparatus may further include an introducing unit (for example, system controller 18 of FIG. 1) for introducing an amount of code per group of pictures (GOP) in response to the information indicating one of the status of the moving image, the status of generation of the moving image, and the process applied to the moving image. The control unit may control the encoding unit so that an amount of code per macro block varies in response to the information with respect to the amount of code per introduced GOP, the macro block being the unit.

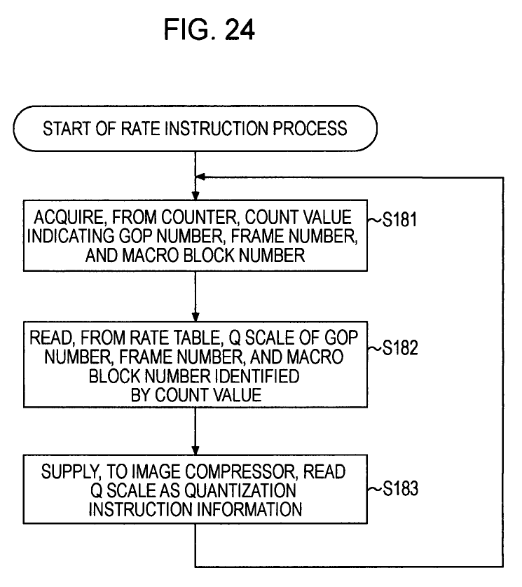

In accordance with one embodiment of the present invention, one of an encoding method and a computer program of an encoding apparatus including processing unit for generating and/or processing a moving image and encoding unit for encoding one of the generated moving image and the processed moving image, includes a step of controlling the encoding unit so that an amount of code per predetermined unit encoded by the encoding unit corresponds to information supplied from the processing unit, the information indicating one of the status of the moving image, the status of generation of the moving image, and a process applied to the moving image (for example, in step S183 of FIG. 24).

FIG. 1 is a block diagram illustrating an encoding apparatus of in accordance with one embodiment of the present invention. The encoding apparatus may be a digital video camera, for example. The encoding apparatus includes an imaging unit 11, an image processor 12, an image compressor 13, a writing unit 14, a recording medium 15, a compression controller 16, a write controller 17, a system controller 18 and an operation key 19. A drive 20 can be connected to the encoding apparatus as necessary. A removable medium 21 can be loaded on the drive 20.

The imaging unit 11 photographs a subject and supplies video data of an image of the photographed subject to the image processor 12. The imaging unit j1 also supplies the system controller 18 with imaging information indicating the status of the photographed subject or the content of the image.

The image processor 12 performs a variety of image processes on the video data supplied from the imaging unit 11. The image processor 12 supplies the processed video data to the image compressor 13. The image processor 12 also supplies the system controller 18 with image processing information indicating the image process applied to the video data or the content of the image.

The image compressor 13 encodes the video data supplied from the image processor 12 at a predetermined encoding method in accordance with quantization instruction information supplied from the compression controller 16. For example, the image compressor 13 encodes the video data in accordance with the moving pictures experts group (MPEG) 2. The quantization instruction information introduces an amount of code that is generated by encoding a predetermined unit of video data. For example, the quantization instruction information is a Q scale to a macro block of the video data.

The image compressor 13 supplies a stream composed of code resulting from the encoding process to the writing unit 14. The image compressor 13 also supplies the compression controller 16 with quantization information indicating an amount of code that is generated by encoding a predetermined unit of video data. For example, the quantization information indicates the Q scale used in the encoding of the macro block of video data and the amount of generated code (hereinafter referred to as code amount).

The writing unit 14 under the control of the write controller 17 writes the stream onto the recording medium 15. The recording medium 15, including an optical disk, records the video data as a stream. Any type of memory is acceptable as the recording medium 15 as long as the memory can record the video data. For example, the recording medium 15 may also be one of a hard disk and a non-volatile semiconductor memory.

The compression controller 16 includes a built-in general-purpose microcomputer or a dedicated system controller. The compression controller 16 controls the encoding process of the image compressor 13 by supplying the image compressor 13 with the quantization instruction information based on rate control information supplied from the system controller 18. The compression controller 16 acquires the quantization information from the image compressor 13.

The rate control information is used to control the encoding process of the video data by the image compressor 13. For example, the rate control information contains the imaging information, the image processing information, and information indicating an amount of code that is generated by encoding the video data by unit larger than an encoding unit indicating an amount of code in the quantization instruction information. More specifically, the rate control information includes the imaging information, the image processing information and the information indicating a bit rate of group of pictures (GOP) of video data.

The compression controller 16 supplies the quantization information to the system controller 18. The quantization information supplied from the compression controller 16 to the system controller 18 may be the same as the quantization information supplied from the image compressor 13 to the compression controller 16. Furthermore, the quantization information supplied from the compression controller 16 to the system controller 18 may additionally include an amount of code that is generated by encoding the video data by larger unit.

The write controller 17 under the control of the system controller 18 controls the writing unit 14 in the writing of the stream onto the recording medium 15.

The system controller 18 includes a built-in general-purpose microcomputer or a dedicated system controller. The system controller 18 controls the compression controller 16 and the write controller 17, thereby controlling the compression of the video data and the recording of the video data onto the recording medium 15. In response to a signal from the operation key 19 operated by a user, the system controller 18 receives the imaging information from the imaging unit 11, receives the image processing information from the image processor 12, acquires the quantization information from the compression controller 16, and supplies the compression controller 16 with the rate control information based on the imaging information, the image processing information and the quantization information.

The drive 20, connected to the encoding apparatus, reads a program recorded on a loaded optical disk, a hard disk drive (HDD), or the removable medium 21 such a semiconductor memory, and then supplies the read program to one of the imaging unit 11, the image processor 12, the image compressor 13, the compression controller 16 and the system controller 18.

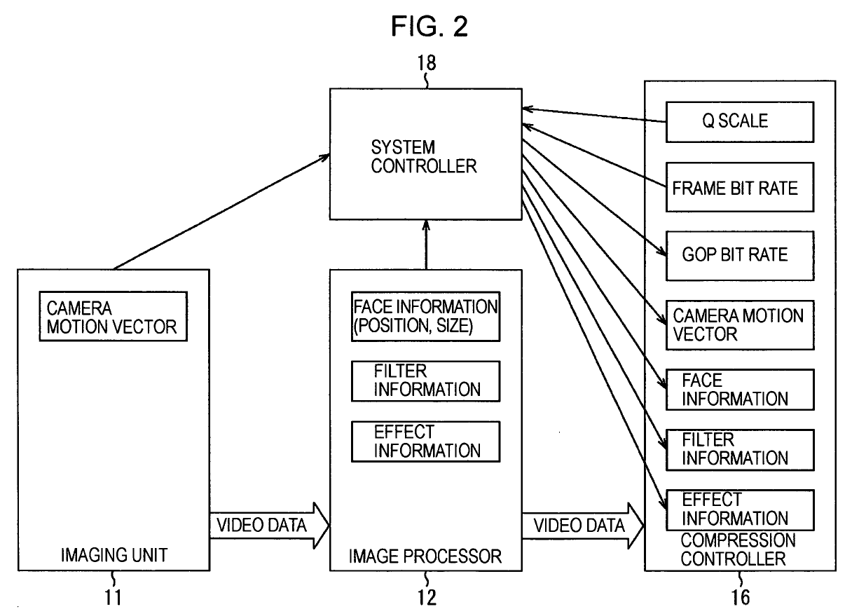

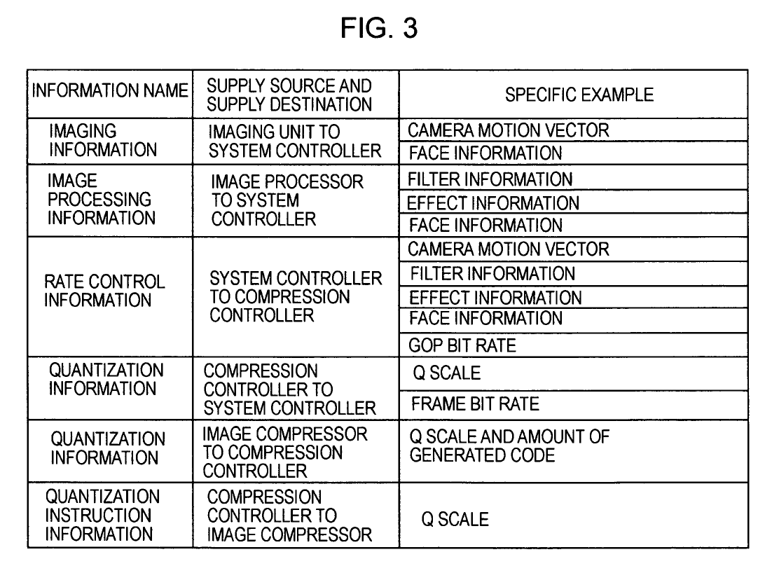

FIGS. 2 and 3 specifically illustrate the imaging information, the image processing information, the rate control information, the quantization information and the quantization instruction information.

The imaging unit 11 supplies a camera motion vector as one example of the imaging information to the system controller 18. The camera motion vector indicates the motion of the imaging unit 11.

The imaging unit 11 supplies face information as one example of the image processing information to the system controller 18.

The image processor 12 supplies the system controller 18 with face information, filter information, and effect information as examples of the image processing information.

The face information relates to an image of a face contained in the image represented by the video data. For example, the face information indicates a position or a size of the face image of the image represented by the video data.

The filter information relates to a filtering process as an image process applied to the image in the image processor 12. For example, the filter information contains a filter identification (ID) specifically identifying the filtering process.

The effect information relates to an effect process as an image process applied to the image in the image processor 12. The effect information contains an effect ID specifically identifying the effect process.

The quantization information supplied from the compression controller 16 to the system controller 18 includes the Q scale and a frame bit rate. The frame bit rate indicates an amount of code that is generated by encoding a frame of the video data.

From the camera motion vector, the face information, the filter information, the effect information, the Q scale and the frame bit rate, the system controller 18 calculates a GOP bit rate indicating an amount of code that is generated by encoding a group of pictures (GOP) of the video data.

Rate control information supplied from the system controller 18 to the compression controller 16 contains the camera motion vector, the face information, the filter information, the effect information and the GOP bit rate.

For example, the quantization instruction information supplied from the compression controller 16 to the image compressor 13 is the Q scale with respect to the macro block of the video data, the macro block being encoded. For example, the quantization information supplied from the image compressor 13 to the compression controller 16 is the Q scale having been used to encode the macro block of the video data and the amount of code.

The image compressor 13 is thus controlled in the encoding operation thereof in response to the information from one of the imaging unit 11 and the image processor 12.

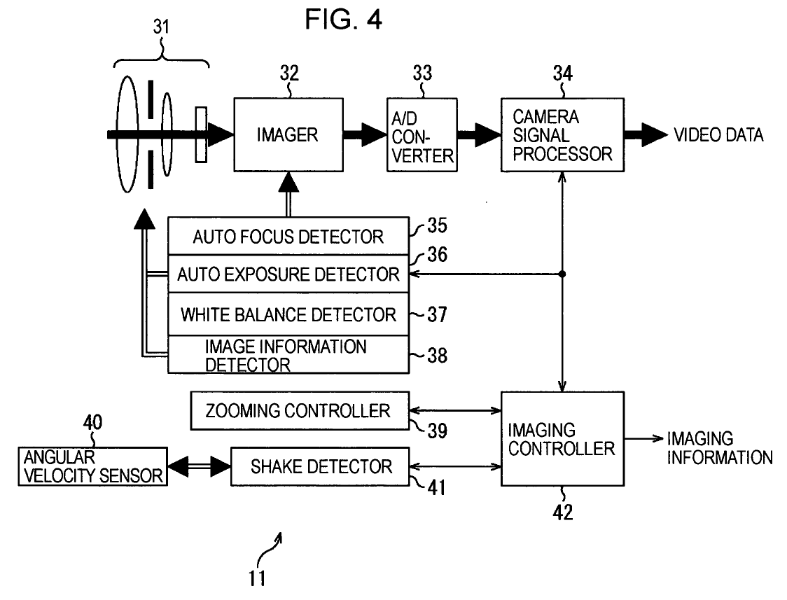

With reference to FIG. 4, the structure of the imaging unit 11 is described below. The imaging unit 11 includes an optical system 31, an imager 32, an analog-to-digital (A/D) converter 33, a camera signal processor 34, an auto focus detector 35, an auto exposure detector 36, a white balance detector 37, an image information detector 38, a zooming controller 39, an angular velocity sensor 40, a shake detector 41 and an imaging controller 42.

The optical system 31, including an objective lens, a zoom lens, and a stop, focuses an optical image of a subject on a photoelectrical converter of the imager 32. The imager 32 includes one of a charge-coupled device (CCD) image sensor and a complementary metal oxide semiconductor (CMOS) image sensor. The imager 32 electrically converts an optical image focused on the photoelectrical converter thereof into an analog electrical signal. The imager 32 supplies the A/D controller 33 with the electrical signal of the image.

The A/D controller 33 converts the analog electrical signal supplied from the imager 32 into a digital electrical signal. The A/D controller 33 supplies the digital electrical signal obtained through conversion to the camera signal processor 34. The camera signal processor 34 thus acquires the video data.

The camera signal processor 34 under the control of the imaging controller 42 performs a variety of image processes such as noise reduction and white balance on the video data. The camera signal processor 34 outputs the video data that has undergone the variety of image processes.

The auto focus detector 35 detects a focus status (degree of focusing) to the subject by the optical system 31 based on one of the signal from the optical system 31 and the signal from the imager 32. The auto focus detector 35 thus outputs AF data indicative of in-focus state to the imaging controller 42.

From one of the signal from the optical system 31 and the signal from the imager 32, the auto exposure detector 36 detects an amount of light incident on the optical system 31, an amount of light incident on the stop and the imager 32, namely, exposure status, and supplies auto exposure (AE) data indicative of the exposure status to the imaging controller 42.

In response to the signal from the camera signal processor 34, the white balance detector 37 detects the content of the white balance process applied to the video data by the camera signal processor 34, namely, the degree of balance correction to each color and then supplies AWB data indicative of the content of the white balance process to the imaging controller 42.

The image information detector 38 detects information relating to the photographed image, and supplies the detected information to the imaging controller 42. The image information detector 38 also acquires the video data from the camera signal processor 34, and processes the acquired video data to detect the position and the size of the face image contained in the photographed image. The image information detector 38 supplies the face information to the imaging controller 42.

The zooming controller 39 under the control of the imaging controller 42 controls the position of the zoom lens in the optical system 31. The zooming controller 39 thus controls the zoom process. The zooming controller 39 supplies the imaging controller 42 with zooming speed data indicative of a zooming speed.

The angular velocity sensor 40 detects an angular velocity of the imaging unit 11 with respect to horizontal and vertical angles of the subject with respect to the optical axis of the imaging unit 11. The angular velocity sensor 40 supplies a signal indicative of the angular velocity to the shake detector 41. For example, the angular velocity sensor 40 detects an angular acceleration, and then detects the angular velocity from the detected angular acceleration.

The shake detector 41 detects a hand shake from the signal supplied from the angular velocity sensor 40, and supplies a camera motion vector as information indicative of the detected result to the imaging controller 42. The camera motion vector represents the motion of a frame adjacent to the photographed image in x and y coordinates.

The imaging controller 42 controls the entire imaging unit 11. The imaging controller 42 also outputs the imaging information indicative of the photographing status or the content of photographed image. For example, the imaging controller 42 outputs the imaging information containing the AF data, the AE data, the AWB data, the zooming speed data, the camera motion vector and the face information.

The image processor 12 is described below.

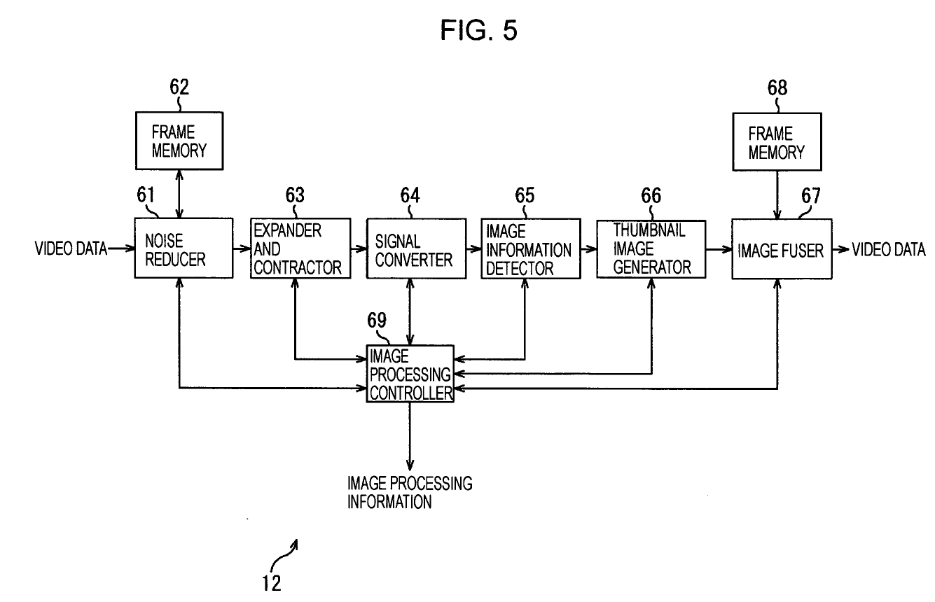

FIG. 5 is a block diagram illustrating the structure of the image processor 12. The image processor 12 of FIG. 5 includes a noise reducer 61, a frame memory 62, an expander and contractor 63, a signal converter 64, an image information detector 65, a thumbnail image generator 66, an image fuser 67, a frame memory 68 and an image processing controller 69.

The noise reducer 61 under the control of the image processing controller 69 reduces a noise component from the video data. For example, the noise reducer 61 causes the frame memory 62 to store temporarily the supplied video data on a per frame basis. On a per frame basis, the noise reducer 61 reduces the noise component from the video data stored on the frame memory 62.

More specifically, the noise reducer 61 detects the noise component from a target frame by comparing the target frame with the preceding frame, each frame stored on the frame memory 62. The noise reducer 61 then removes the detected noise component from the target frame. The noise reducer 61 causes the frame memory 62 to store the frame from which the noise component has been reduced.

The noise reducer 61 further compares the noise reduced frame stored on the frame memory 62 with the next target frame stored on the frame memory 62, thereby detecting a noise component from the next target frame. The noise reducer 61 reduces the noise component from the next target frame. The noise reducer 61 causes the frame memory 62 to store the noise-free next target frame.

By repeating the above-described process on each frame, the noise reducer 61 reduces the noise component from the video data.

The noise reducer 61 supplies the noise-free video data to the expander and contractor 63. The noise reducer 61 supplies information indicative of the noise reduction process to the image processing controller 69. If it is not necessary to reduce noise, the noise reducer 61 supplies the video data with the noise thereof unreduced to the expander and contractor 63.

The expander and contractor 63 under the control of the image processing controller 69 expands or contracts the image. For example, the expander and contractor 63 expands the image by interpolating the image or contracts the image decimating the image.

The expander and contractor 63 supplies the video data of one of the expanded image and the contracted image to the signal converter 64. Neither expansion nor contraction is required, the expander and contractor 63 supplies the video data in the original form thereof to the signal converter 64.

The expander and contractor 63 supplies information indicative of the image expansion process or the image contraction process to the image processing controller 69.

The signal converter 64 under the control of the image processing controller 69 performs a variety of signal conversion processes including a filtering process and an effect process to the video data supplied from the expander and contractor 63. The signal converter 64 may perform a conversion process to convert the image into a sepia tone image or a monochrome image, a negative-positive reversal process, a mosaic process, an unsharpening process, etc. on the video data. For example, the signal converter 64 performs a filtering process on the video data for low-pass filtering.

The signal converter 64 supplies such signal processed video data to the image information detector 65.

If it is not necessary to perform such image processes, the signal converter 64 supplies the video data from the expander and contractor 63 in the unprocessed form to the image information detector 65.

The signal converter 64 supplies information indicative of the signal process performed on the video data to the image processing controller 69.

The image information detector 65 under the control of the image processing controller 69 detects a variety of information relating to the image from the video data supplied from the signal converter 64. For example, the image information detector 65 detects an image of a face contained in the image, thereby detecting a position and a size of the face image, and a character contained in the image.

The image information detector 65 supplies information indicative of the detection results to the image processing controller 69. The image information detector 65 also supplies the video data to the thumbnail image generator 66.

The thumbnail image generator 66 under the control of the image processing controller 69 generates a thumbnail image as a scale contracted image from the video data supplied from the image information detector 65. For example, the thumbnail image generator 66 generates the thumbnail image into which the entire image indicative of the video data is contacted. The thumbnail image generator 66 generates a thumbnail image into which the face image detected by the image information detector 65 is scale contracted.

The thumbnail image generator 66 supplies the generated thumbnail image to the image fuser 67. The thumbnail image generator 66 also supplies the video data of the generated thumbnail image to the image processing controller 69.

The image fuser 67 under the control of the image processing controller 69 fuses the image represented by the original video data supplied from the thumbnail image generator 66 and a graphic image represented by the video data pre-stored on the frame memory 68. For example, the image fuser 67 transmissively fuses the image represented by the original video data supplied from the thumbnail image generator 66 and the graphic image represented by the video data pre-stored on the frame memory 68 by performing a blending process on the original video data supplied from the thumbnail image generator 66 and the video data pre-stored on the frame memory 68. Also, for example, the image blender 67 fuses the image represented by the original video data supplied from the thumbnail image generator 66 and the graphic image represented by the video data pre-stored on the frame memory 68 so that each image fades in or out.

If it is not necessary to fuse the images, the image blender 67 outputs the original video data supplied from the thumbnail image generator 66 with no fusing process performed thereon.

The image processing controller 69 generates and outputs the image processing information indicative of the process performed on the image or the content of the image from the signal supplied from one of the noise reducer 61, the expander and contractor 63, the signal converter 64 and the image information detector 65.

For example, the image processing controller 69 outputs information regarding the noise reduction process, the information regarding the image expansion process or the image contraction process, the information regarding a variety of signal processes including the filtering process and the effect process, and a variety of information regarding the image. More specifically, the image processing controller 69 outputs the image processing information containing an effect ID identifying an effect performed on the video data and information regarding the effect, and a filter ID identifying a filter applied to the video data and information regarding the filter.

The image processor 12 outputs the image processing information regarding the image process applied to the image or the content of the image.

The structure of the image compressor 13 is described below with reference to a block diagram of FIG. 6.

The image compressor 13 includes a pre-processor 81 and an encoder 82. The pre-processor 81 converts the video data into data appropriate for an encoding process performed by the encoder 82 while extracting information about the image required for the encoding process of the encoder 82.

The encoder 82 encodes the video data converted by the pre-processor 81 in accordance with a predetermined encoding method using the information extracted by the pre-processor 81.

The pre-processor 81 includes a pre-processing unit 91, a frame memory 92 and a motion vector detector 93. The pre-processing unit 91 performs a definition conversion process, namely, a frequency characteristic conversion process on the video data while performing a pixel count conversion process, namely, a sample number conversion process on the video data. The pre-processing unit 91 supplies the definition converted and pixel count converted video data to the frame memory 92.

The frame memory 92 temporarily stores, by frame, the video data supplied from the pre-processing unit 91, and supplies the stored video data to the encoder 82. The frame memory 92 re-arranges the frames depending on picture types from among I picture, B picture, and P picture, and supplies the video data in the re-arranged picture order to the encoder 82.

The frame memory 92 is so designed that the motion vector detector 93 can read the stored video data.

The motion vector detector 93 detects a motion vector from the video data stored on the frame memory 92 and supplies the detected motion vector to the encoder 82. For example, the frame memory 92 detects the motion vector using a block matching technique.

The encoder 82 includes a subtractor 94, a discrete cosine transform (DCT) unit 95, a quantizer 96, a variable length encoder 97, a buffer 98, a quantization controller 99, a dequantizer 100, an inverse DCT unit 101, an adder 102, a frame memory 103, a motion compensator 104 and a switch 105.

The subtractor 94 subtracts from a frame of the video data supplied from the pre-processor 81 a motion compensated frame supplied from the motion compensator 104 via the switch 105. The subtractor 94 then supplies the resulting difference to the DCT unit 95 or the video data supplied from the pre-processor 81 as is to the DCT unit 95.

The DCT unit 95 performs the discrete cosine transform process on the data supplied from the subtractor 94. The DCT unit 95 supplies to the quantizer 96 a DCT code obtained as a result of discrete cosine transform process. The quantizer 96 under the rate control of the quantization controller 99 quantizes the DCT code supplied from the DCT unit 95. In other words, the quantizer 96 quantizes the DCT code in accordance with the Q scale provided by the quantization controller 99.

The quantizer 96 supplies the quantized DCT code to the variable length encoder 97 and the dequantizer 100.

The variable length encoder 97 variable encodes the quantized DCT code, and supplies the variable encoded DCT code to the buffer 98. The buffer 98 temporarily stores the code supplied from the variable length encoder 97 and then outputs the code as a stream.

The quantization controller 99 controls the quantizer 96 in the DCT code quantization process thereof based on the data amount of code stored on the buffer 98 and the quantization instruction information so that the data amount of the quantized DCT code becomes appropriate. More specifically, the quantization controller 99 supplies to the quantizer 96 the Q scale making appropriate the data amount of the quantized DCT code based on the data amount of the code stored on the buffer 98 and the quantization instruction information.

The quantization controller 99 outputs as the quantization information the Q scale to be supplied to the quantizer 96 and the generated code amount.

The dequantizer 100 performs on the DCT code quantized by the quantizer 96 a dequantization process that is an inverse process to the quantization process performed by the quantizer 96. The inverse DCT unit 101 performs on the DCT code dequantized by the dequantizer 100 an inverse discrete cosine transform (DCT) that is an inverse process to the discrete cosine transform process performed by the DCT unit 95. The inverse DCT unit 101 thus decodes the frame of the video data. The inverse DCT unit 101 supplies the decoded frame to the adder 102.

The adder 102 sums the motion compensated frame supplied from the motion compensator 104 and the frame decoded by the inverse DCT unit 101 and supplies the resulting summed frame to the frame memory 103.

The frame memory 103 stores the frame supplied from the adder 102. The motion compensator 104 compensates for the frame stored on the frame memory 103 in response to the motion vector supplied from the pre-processor 81 and supplies the motion compensated frame to each of the switch 105 and the adder 102.

The switch 105 switches between supplying the motion compensated frame and not supplying the motion compensated frame. If the frame is encoded without referencing another frame, the switch 105 is controlled to connect a point b to an input terminal of the subtractor 94. With no motion compensated frame supplied, the subtractor 94 supplies the frame supplied from the pre-processor 81, as is, to the DCT unit 95.

If the frame is encoded with another frame being referenced, the switch 105 is controlled to connect a point a to the input terminal of the subtractor 94. The subtractor 94 is thus supplied with the motion compensated frame. The subtractor 94 supplies to the DCT unit 95 a resulting difference that is obtained by subtracting the motion compensated frame from the frame supplied from the pre-processor 81.

The image compressor 13 generates and then outputs a stream of a predetermined data amount responsive to the quantization instruction information.

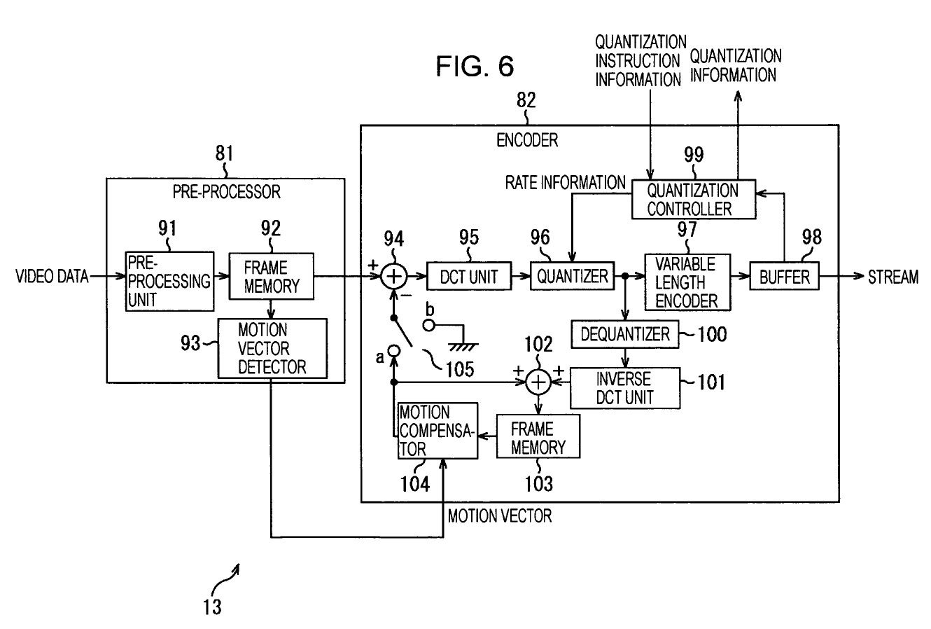

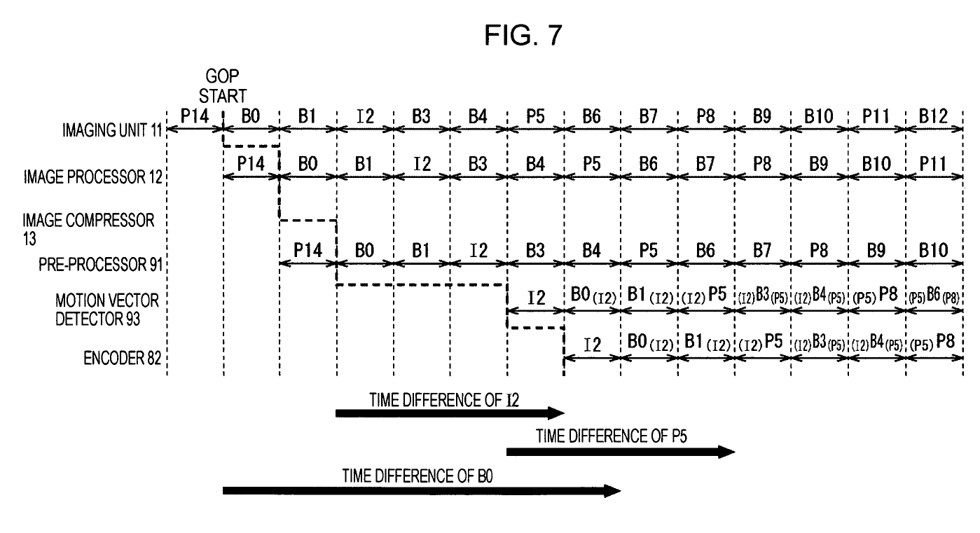

FIG. 7 illustrates a time difference between the time of acquisition of the imaging information or the image processing information of the frame and the time of encoding the frame.

The horizontal directions denoted by arrows represent time in FIG. 7.

FIG. 7 illustrates, from above to below, the order of frames to be photographed by the imaging unit 11, the order of frames image processed by the image processor 12, the order of frames to be pre-processed by the pre-processing unit 91 in the image compressor 13, the order of frames from which motion is detected by the motion vector detector 93, and the order of frames to be encoded by the encoder 82.

As shown in FIG. 7, the imaging unit 11 photographs sequentially frame P14, frame B0, frame B1, frame I2, frame B3, frame B4, frame P5, frame B6, frame B7, frame P8, frame B9, frame B10, frame P11, frame B12, frame B13, frame P14, . . . in that order. The imaging unit 11 supplies the frame in the order of photographing to the image processor 12.

One group of pictures (GOP) includes 15 frames of frame B0 through frame P14.

The image processor 12 sequentially image processes the frames the frames supplied from the imaging unit 11. The image processor 12 thus image processes the frame P14, frame B0, frame B1, frame I2, frame B3, . . . in that order with a delay of one frame from those in the imaging unit 11.

The pre-processing unit 91 in the image processor 12 sequentially pre-processes the frames supplied from the imaging unit 11. The pre-processing unit 91 thus pre-processes the frame P14, frame B0, frame B1, frame I2, frame B3, . . . in that order with a delay of one frame from those in the image processor 12.

The frames pre-processed by the pre-processing unit 91 and stored on the frame memory 92 are re-arranged in the order of encoding by the encoder 82. More specifically, frame B0, frame B1, frame I2, frame B3, frame B4, frame P5, frame B6, frame B7, frame P8, frame B9, frame B10, frame P11, frame B12, frame B13, and frame P14 are re-arranged as frame I2, frame B0, frame B1, frame P5, frame B3, frame B4, frame P8, frame B6, frame B7, frame P11, frame B9, frame B10, frame P14, frame B12 and frame B13 in that order. 371 As shown in FIG. 7, B0_{(I2)} shows that the frame B0 is predicted from the frame I2 after the frame B0, _{(I2)}P5 shows that the frame P5 is predicted from the frame I2 before the frame P5, and _{(I2)}B3_{(P5)} shows that the frame B3 is predicted from the frame I2 before the frame B3 and the frame P5 after the frame B3. More specifically, the frame B0 is encoded from a difference between the frame B0 and the frame I2 after the frame B0, the frame P5 is encoded from a difference between the frame P5 and the frame I2 before the frame P5, and the frame B3 is encoded from a difference between the frame B3 and the frame I2 before the frame I2 and a difference between the frame B3 and the frame P5 after the frame B3.

The motion vector detector 93 detects a motion vector from the frames re-arranged with a delay of three frames with respect to the frames in the pre-processing unit 91.

The encoder 82 encodes the frames re-arranged with a delay of one frame introduced with respect to the frames in the motion vector detector 93.

A time difference of four frames takes place between the time of photographing the frame I2 by the imaging unit 11 and the time of encoding the frame I2 by the encoder 82. More specifically, the encoder 82 encodes the frame I2 with a delay time of four frames with respect to the time of photographing I2 by the imaging unit 11.

A time difference of four frames takes place between the time of photographing the frame P5 by the imaging unit 11 and the time of encoding the frame P5 by the encoder 82. More specifically, the encoder 82 encodes the frame P5 with a delay time of four frames with respect to the time of photographing P5 by the imaging unit 11.

A time difference of seven frames takes place between the time of photographing the frame B0 by the imaging unit 11 and the time of encoding the frame B0 by the encoder 82. More specifically, the encoder 82 encodes the frame B0 with a delay time of seven frames with respect to the time of photographing B0 by the imaging unit 11.

A time difference of three frames takes place between the time of image processing the frame I2 by the image processor 12 and the time of encoding the frame I2 by the encoder 82. More specifically, the encoder 82 encodes the frame I2 with a delay time of three frames with respect to the time of image processing I2 by the image processor 12.

A time difference of three frames takes place between the time of image processing the frame P5 by the image processor 12 and the time of encoding the frame P5 by the encoder 82. More specifically, the encoder 82 encodes the frame P5 with a delay time of three frames with respect to the time of image processing P5 by the image processor 12.

A time difference of six frames takes place between the time of image processing the frame B0 by the image processor 12 and the time of encoding the frame B0 by the encoder 82. More specifically, the encoder 82 encodes the frame B0 with a delay time of six frames with respect to the time of image processing B0 by the image processor 12.

As shown in FIG. 7, the frame encoded by the encoder 82 is photographed by the imaging unit 11 at least four frames earlier.

As shown in FIG. 7, the frame encoded by the encoder 82 is image processed by the image processor 12 at least three frames earlier.

The imaging information or the image processing information regarding the frames to be encoded by the image compressor 13 is obtained prior to the encoding process of the image compressor 13.

The video data is thus encoded more appropriately by controlling the image compressor 13 in the encoding of the video data using the imaging information or the image processing information.

The encoding of the video data by the image compressor 13 is controlled using the imaging information containing one of the AF data, the AE data, the AWB data, the zooming speed data, the camera motion vector and the face information, the information regarding the reduction process of the noise component, the information regarding the image expansion and the image contraction process, the information regarding the variety of signal processes including one of the filtering process and the effect process, or the image processing information containing a variety of information related to image such as face image.

Control process of controlling the encoding of the video data in accordance with the imaging information or the image processing information is described below. For example, the control process of controlling the encoding of the video data is performed based on the camera motion vector as one example of the imaging information, the one of the filter ID and the effect ID as one example of the image processing information, and the face information as one example of the one of the imaging information and the image processing information.

A variety of tables stored in the compression controller 16 and containing the rate control information, the quantization information and the quantization instruction information is described below.

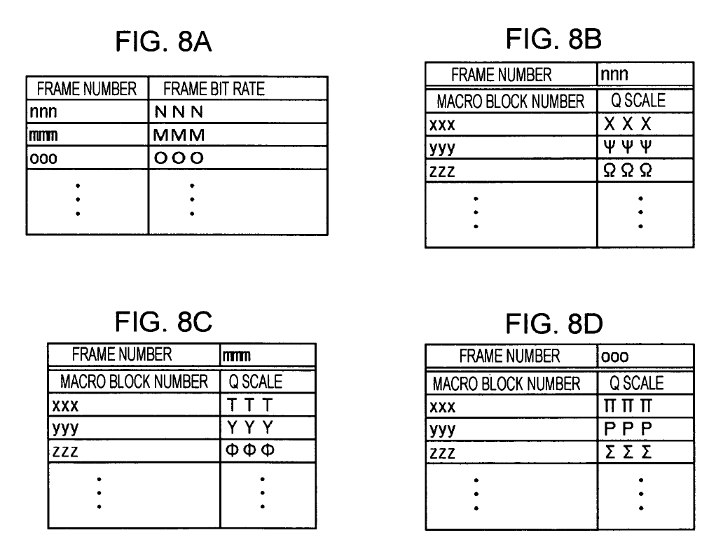

FIGS. 8A-8D illustrate quantization information tables stored in the compression controller 16 and containing the quantization information. The quantization information tables include a table listing a frame bit rate indicating an amount of code generated as a result of encoding each frame, and a table for each frame listing a Q scale used in the encoding of each macro block.

FIG. 8A illustrates a table listing frame bit rates. The table lists a frame number identifying each frame and a frame bit rate of that frame in association with the frame number. More specifically, a frame bit rate NNN is listed in association with a frame number nnn, a frame bit rate MMM is listed in association with a frame number mmm, and a frame bit rate OOO is listed in association with frame number ooo.

FIGS. 8B-8D illustrate tables listing Q scales. The table of FIG. 8B represented by a frame number nnn lists Q scales used in the encoding the macro block in the frame identified by the frame number nnn.

In the table of FIG. 8B listing the Q scale, a Q scale XXX is listed in association with a macro block number xxx. The Q scale XXX is thus used in the encoding the macro block identified by the macro block number xxx. Similarly, in the table of FIG. 8B, a Q scale ΨΨΨ is listed in association with a macro block number yyy and a Q scale ΩΩΩ is listed in association with the macro block number zzz. In the frame identified by the frame number nnn, the Q scale ΨΨΨ is used in encoding the macro block identified by the macro block number yyy and the scale ΩΩΩ is used in encoding the macro block identified by the macro block number zzz.

The table of FIG. 8C for the frame identified by a frame number mmm lists a Q scale TTT used in encoding a macro block identified by the macro block number xxx, a Q scale YYY used in encoding a macro block identified by the macro block number yyy, and a Q scale ΦΦΦ used in encoding a macro block identified by the macro block number zzz.

The table of FIG. 8D for the frame identified by a frame number ooo lists a Q scale ΠΠΠ used in encoding a macro block identified by the macro block number xxx, a Q scale PPP used in encoding a macro block identified by the macro block number yyy, and a Q scale ΣΣΣ used in encoding a macro block identified by the macro block number zzz.

The quantization information table in the compression controller 16 lists the quantization information composed of the frame bit rate indicating the amount of code generated as a result of encoding each frame and the Q scale used in encoding the macro block.

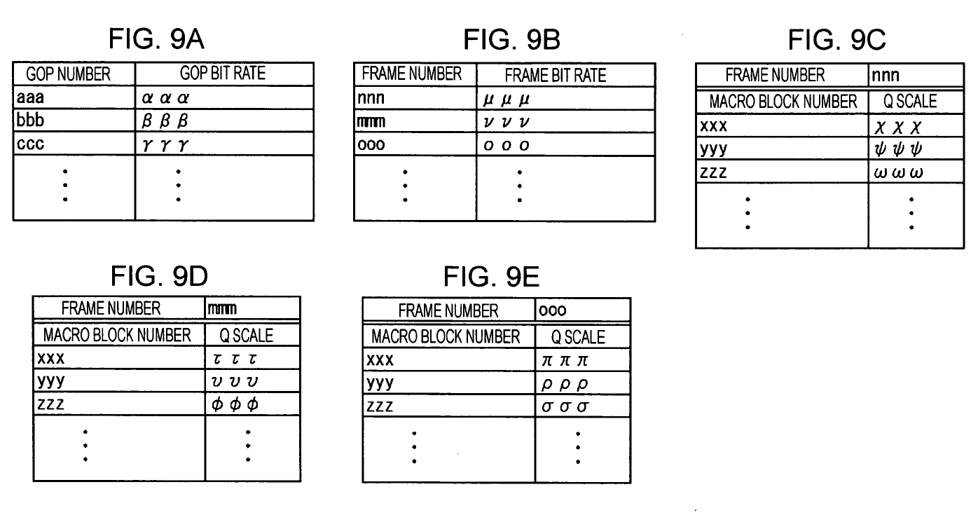

FIGS. 9A-9D illustrate rate tables. The rate table lists a GOP bit rate contained in the rate control information, a frame bit rate indicating an amount of code of a frame to be encoded, and quantization instruction information as a Q scale for a macro block to be encoded.

For example, the tables include a table listing a GOP bit rate for each GOP to be encoded, a table listing a frame bit rate indicating an amount of code of each frame to be encoded, and a table for each frame listing a Q scale to be used in encoding each macro block to be encoded.

FIG. 9A illustrates the table listing the GOP bit rates. The table of FIG. 9A lists a GOP number identifying each GOP and a GOP bit rate for that GOP in association with each other. More specifically, a GOP bit rate ααα is listed in association with a GOP number aaa, a GOP bit rate βββ is listed in association with a GOP number bbb, and a GOP bit rate γγγ is listed in association with a GOP number ccc.

FIG. 9B illustrates the table listing the frame bit rates, namely, a frame number identifying each frame to be encoded and a frame bit rate in association with the frame number. For example, a frame bit rate μμμ is listed in association with a frame number nnn, a frame bit rate vvv is listed in association with a frame number mmm, and a frame bit rate ooo is listed in association with a frame number ooo.

FIG. 9C illustrates the table listing the Q scale for a frame identified by nnn. The table of FIG. 9C lists a Q scale χχχ used as the quantization instruction information in encoding a macro block identified by a macro block number xxx, a Q scale ψψψ used as the quantization instruction information in encoding a macro block identified by a macro block number yyy, and a Q scale ωωω used as the quantization instruction information in encoding a macro block identified by a macro block number zzz.

FIG. 9D illustrates the table listing the Q scale for a frame identified by mmm. The table of FIG. 9D lists a Q scale τττ used as the quantization instruction information in encoding a macro block identified by a macro block number xxx, a Q scale ννν used as the quantization instruction information in encoding a macro block identified by a macro block number yyy, and a Q scale φφφ used as the quantization instruction information in encoding a macro block identified by a macro block number zzz.

FIG. 9E illustrates the table listing the Q scale for a frame identified by ooo. The table of FIG. 9E lists a Q scale πππ used as the quantization instruction information in encoding a macro block identified by a macro block number xxx, a Q scale ρρρ used as the quantization instruction information in encoding a macro block identified by a macro block number yyy, and a Q scale σσσ used as the quantization instruction information in encoding a macro block identified by a macro block number zzz.

In this way, the rate tables in the compression controller 16 list the GOP bit rate indicating the amount of code generated in the encoding of each GOP, the frame bit rate indicating the amount of code to be generated in the encoding of each frame, and the Q scale to be used as the quantization instruction information in the encoding of each macro block.

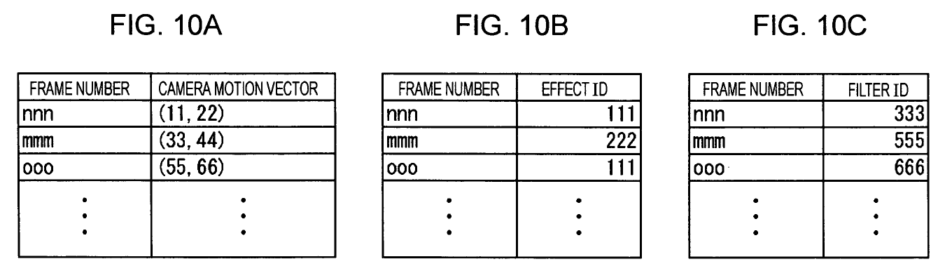

FIGS. 10A-10C illustrate an imaging information table listing the imaging information and a image processing information table listing the image processing information.

FIG. 10A illustrates a motion vector table as one example of the imaging information table. The motion vector table lists a camera motion vector as one example of the imaging information. For example, the motion vector table lists a frame number identifying a frame, and a camera motion vector detected in the frame identified by the frame number in association with each other. In the motion vector table of FIG. 10A, a frame number nnn and a camera motion vector (11,22) are listed in association with each other, a frame number nnn and a camera motion vector (33,44) are listed in association with each other, and a frame number ooo and a camera motion vector (55,66) are listed in association with each other.

The camera motion vector is represented by (x1, y1) where x1 represents an x coordinate component and y1 represents a y coordinate component.

The image processing information table of FIG. 10B is an effect table. The effect table lists an effect ID identifying an effect process contained in the effect information as one example of the image processing information. For example, the effect table lists a frame number identifying a frame, and an effect ID identifying an effect applied to the frame identified by the frame number in association with each other. For example, the effect table of FIG. 10B lists a frame number nnn and an effect ID 111 in association with each other, a frame number mmm and an effect ID 222 in association with each other, and a frame number ooo and an effect ID 111 in association with each other.

For example, an effect for converting the image into a monochrome image is identified by the effect ID 111, and an effect for a negative-position converting operation is identified by the effect ID 222.

The image processing information table of FIG. 10C is a filter table. The filter table lists a filter ID specifically identifying a filtering process contained in the face information as one example of the image processing information. For example, the filter table lists a frame number identifying a frame, and a filter ID identifying a filtering process applied to the frame identified by the frame number in association with each other. As shown in FIG. 10C, a frame number nnn and a filter ID 333 are listed in association with each other, a frame number mmm and a filter ID 555 are listed in association with each other, and a frame number ooo and a filter ID 666 are listed in association with each other.

For example, the filter ID 333 identifies a low-pass filtering process in which a corner frequency (cutoff frequency) with a sampling frequency normalized by 2 is 0.6, the filter ID 555 identifies a low-pass filtering process in which a corner frequency with a sampling frequency normalized by 2 is 0.72, and the filter ID 666 identifies a filtering process for noise reduction.

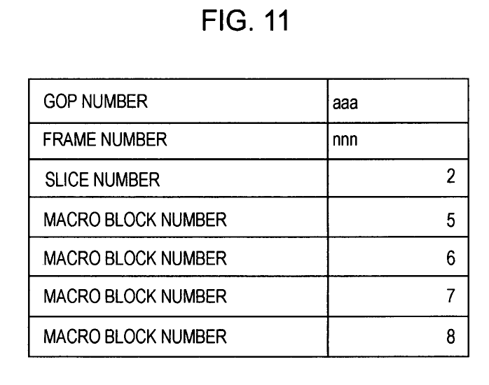

FIG. 11 illustrates a face macro block identification table in the compression controller 16 listing information indicating a macro block forming the face image.

When the face information indicating the position and the size of the face image is supplied from one of the imaging unit 11 and the image processor 12, the system controller 18 recognizes a macro block forming the face image from the face information. The system controller 18 stores the information indicating the macro block forming the face image into the face macro block identification table in the compression controller 16.

The face macro block identification table of FIG. 11 lists a GOP number identifying a GOP of the frame from which the face image is detected, a frame number identifying the frame of the face image, a slice number identifying a slice forming the face image, and macro block numbers identifying the macro blocks forming the face image.

The face macro block identification table of FIG. 11 specifically lists a GOP number aaa, a frame number nnn, a slice number 2, a macro block number 5, a macro block number 6, a macro block number 7, and a macro block number 8. The face image is constructed of the slice number 2, and macro blocks identified by the macro block numbers 5-8 in the frame identified by the frame number nnn belonging to the GOP identified by the GOP number aaa.

The compression controller 16 thus stores the rate control information containing the camera motion vector, the filter information, the effect information and the face information.

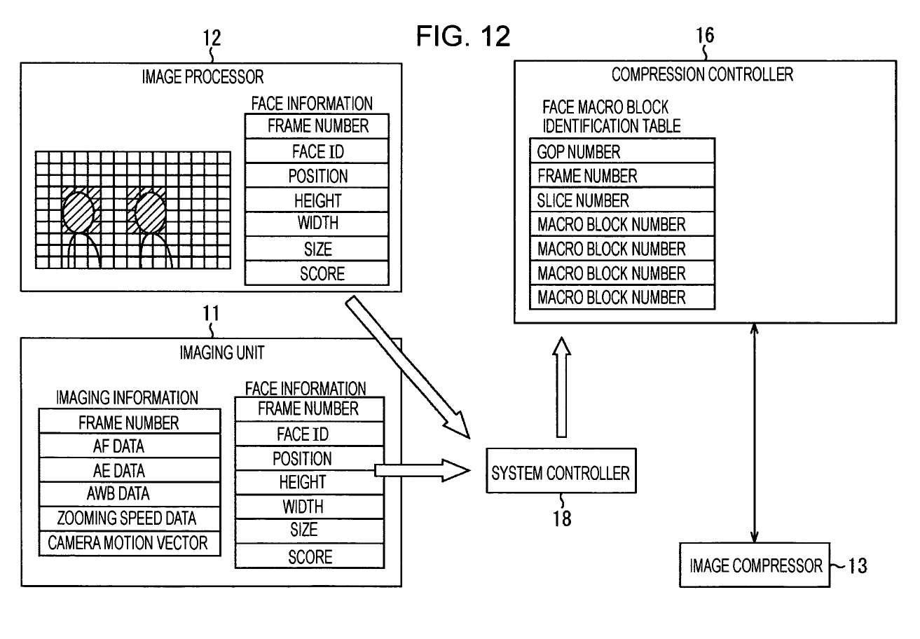

FIG. 12 illustrates a summary of a process from detecting the image of the face to storing in the face macro block identification table the macro block number identifying the macro block forming the face image.

The imaging unit 11 supplies to the system controller 18 the imaging information containing the frame number, the AF data, the AE data, the AWB data, the zooming speed data and the camera motion vector. To detect the face image from the photographed image, the imaging unit 11 supplies to the system controller 18 the face information related to the face image, as the imaging information, the face information containing a frame number, face ID, position, height, width, size and score.

When the image processor 12 detects the face image from the photographed image, the image processor 12 supplies to the system controller 18 the face information related to the face image, as the image processing information, the face information containing a frame number, face ID, position, height, width, size and score.

The frame number of the face information identifies the frame from which the face image has been detected.

The face ID identifies the face image. The position identifies the position of the face image in the photographed image or in the image to be signal processed. The height and width represent the height and the width of the face image. The size represents the area of the face image. The score represents the probability that the detected image is the face image.

Upon receiving the face information containing the position and the size of the face image from one of the imaging unit 11 and the image processor 12, the system controller 18 identifies the macro block forming the face image from the face information. The system controller 18 stores in the face macro block identification table of the compression controller 16, discussed with reference to FIG. 11, the GOP number identifying the GOP of the frame from which the face image has been detected, the frame number identifying the frame from which the face image has been detected, the slice number identifying the slice forming the face image, and the macro block number identifying the macro block forming the face image.

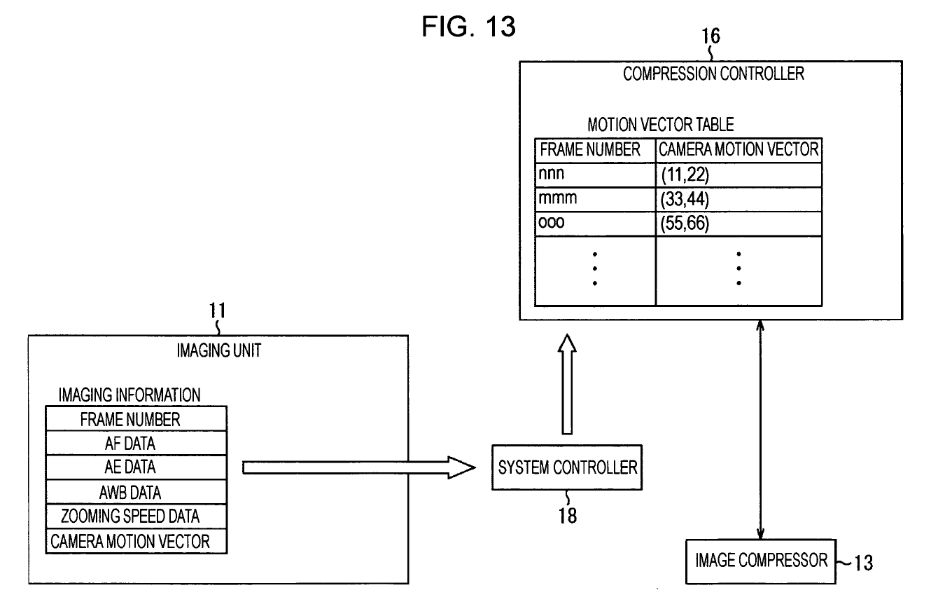

FIG. 13 illustrates a summary of a process from detecting the imaging information to storing the camera motion vector in the motion vector table.

The imaging unit 11 supplies to the system controller 18 the frame number, the AF data, the AE data, the AWB data, the zooming speed data and the camera motion vector.

The system controller 18 extracts the camera motion vector from the imaging information and writes in the motion vector table of the compression controller 16 the frame number identifying the frame, and the camera motion vector detected from the frame identified by the frame number in association with each other.

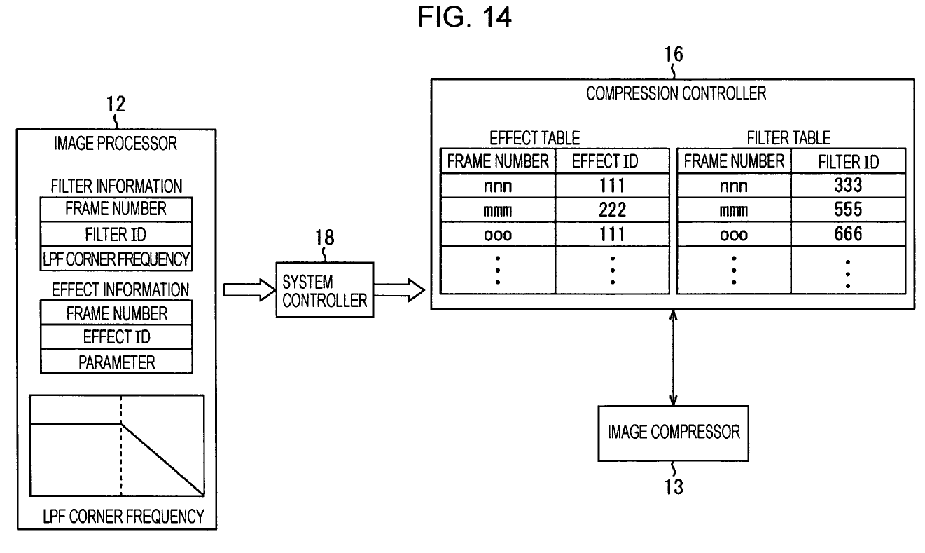

FIG. 14 illustrates a summary of a process from detecting the image processing information to storing the effect information in the effect table to storing the filter ID in the filter table.

The image processor 12 supplies the system controller 18 with the image processing information containing the filter information and the effect information. The filter information contains the frame number, the filter ID, and a low-pass filter (LPF) corner frequency. The effect information contains the frame number, the effect ID, and a parameter.

The parameter contained in the effect information determines the intensity and direction of the effect applied to the frame and identified by the effect ID.

The system controller 18 extracts the frame number and the filter ID from the filter information of the image processing information, and writes in the filter table of the compression controller 16 the frame number identifying the frame having undergone the filtering process and the filter ID identifying the filtering process in association with each other.

The system controller 18 extracts the frame number and the effect ID from the effect information of the image processing information, and writes in the effect table of the compression controller 16 the frame number identifying the frame having undergone the effect and the effect ID identifying the effect.

The process of the encoding apparatus is described below with reference to flowcharts.

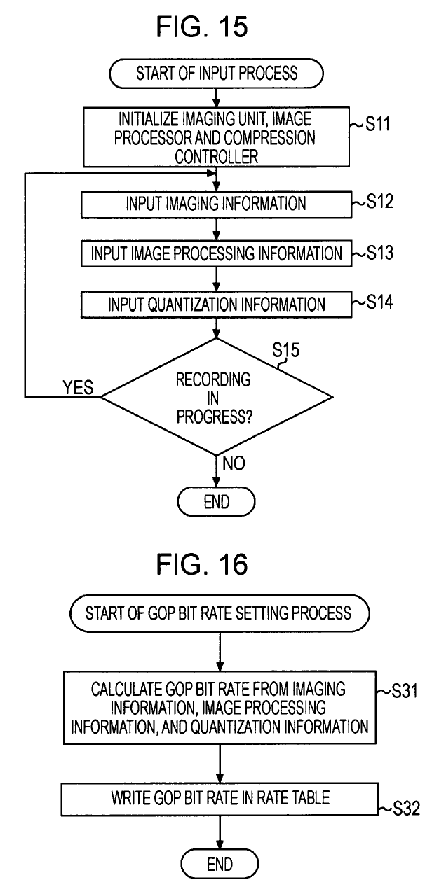

FIG. 15 is a flowchart illustrating an input process of the system controller 18. In step S11, the system controller 18 initializes the imaging unit 11, the image processor 12 and the compression controller 16. For example, the system controller 18 initializes the imaging unit 11, the image processor 12 and the compression controller 16 by transmitting a predetermined command to each of the imaging unit 11, the image processor 12 and the compression controller 16. An operational status of each of the imaging unit 11, the image processor 12 and the compression controller 16 becomes an initial mode.

In step S12, the system controller 18 receives the imaging information from the imaging unit 11. For example, upon photographing one frame, the imaging unit 11 transmits the imaging information regarding the photographed frame to the system controller 18. The system controller 18 thus receives the imaging information transmitted from the imaging unit 11. Also, the system controller 18 continuously monitors the photographing status of the imaging unit 11. When one frame is photographed, the imaging unit 11 stores the imaging information regarding the photographed frame onto a predetermined memory area. The system controller 18 thus receives the imaging information by reading the imaging information from the memory area of the imaging unit 11.

In step S13, the system controller 18 receives the image processing information from the image processor 12. Upon completing the image process on one frame, the image processor 12 transmits the image processing information regarding the frame having undergone the image process to the system controller 18. The system controller 18 thus receives the image processing information from the image processing information transmitted from the image processor 12. The system controller 18 continuously monitors the execution status of the image process of the image processor 12. When the image process is performed on the one frame, the image processor 12 stores onto a predetermined memory area thereof the image processing information regarding the frame having undergone the image process. The system controller 18 thus receives the image processing information by reading the image processing information from the memory area of the image processor 12.

In step S14, the system controller 18 receives the quantization information from the compression controller 16. When the image compressor 13 completes the encoding process on one frame, the compression controller 16 transmits the quantization information regarding the encoded frame to the system controller 18. The system controller 18 thus receives the quantization information from the compression controller 16. The system controller 18 further continuously monitors the status of the compression controller 16 that controls the encoding process of the image compressor 13. When the image compressor 13 completes the encoding of one frame, the compression controller 16 stores onto a predetermined memory area thereof the quantization information regarding the encoded frame. The system controller 18 thus receives the quantization information by reading the quantization information at the memory area of the compression controller 16.

In step S15, the system controller 18 determines whether a recording process is in progress, i.e., whether the video data as a stream is continuously written onto the recording medium 15. If it is determined in step S15 that the recording process is in progress, the encoding of the video data is being performed. Processing returns to step S12 to repeat step S12 and subsequent steps.

If it is determined in step S15 that the recording process is not in progress, it is not necessary to input the imaging information, the image processing information and the quantization information any longer. The input process thus ends.

A GOP bit rate setting process performed by the system controller 18 on each GOP is described below with reference to a flowchart of FIG. 16. In step S31, the system controller 18 calculates a GOP bit rate from the imaging information, the image processing information and the quantization information input in the input process.

For example, in step S31, the system controller 18 determines as a reference the GOP bit rate from a bit rate of the stream that is determined based on a recording mode. The system controller 18 further corrects the GOP bit rate by referencing the imaging information, the image processing information and the quantization information, thereby calculating the final GOP bit rate.

Alternatively, in step S31, the system controller 18 may calculate the final GOP bit rate by simply determining the GOP bit rate from the bit rate of the stream determined from the recording mode.

In step S32, the system controller 18 writes the GOP bit rate calculated in step S31 in the rate table of the compression controller 16. Processing thus ends. For example, in step S32, the system controller 18 writes the GOP number identifying the GOP as a target for GOP bit rate calculation and the GOP bit rate in association with each other in a table listing the GOP bit rate from among the bit rate tables as discussed with reference to FIGS. 9A-9D.

The rate table thus lists the GOP bit rate on a per GOP basis in the GOP bit rate setting process.

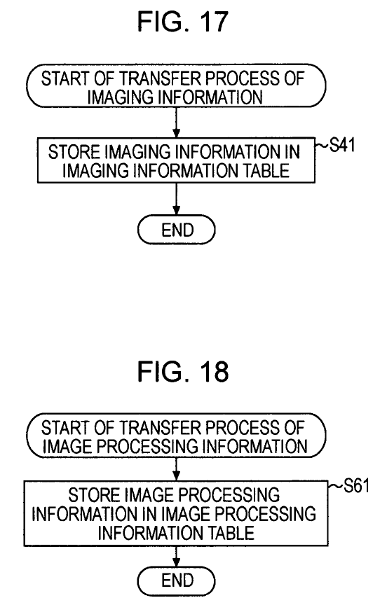

A transfer process of the imaging information performed by the system controller 18 in response to each input of the imaging information is described below with reference to a flowchart of FIG. 17. In step S41, the system controller 18 stores the imaging information input in the input process onto the imaging information table of the compression controller 16. Processing thus ends.

For example, in step S41, the system controller 18 writes the camera motion vector contained in the imaging information and the frame number identifying the frame, from which the camera motion vector has been detected, in the motion vector table as one example of the imaging information table discussed with reference to FIG. 10A-10C. The camera motion vector is written in association with the frame number.

The imaging information such as the camera motion vector is thus transferred to the compression controller 16.

A transfer process of the image processing information performed by the system controller 18 in response to each input of the image processing information is described below with reference to FIG. 18. In step S61, the system controller 18 stores into the image processing information table the image processing information input in the input process. Processing thus ends.

For example, in step S61, the system controller 18 writes the filter ID contained in the filter information of the image processing information and the frame number in association with each other in the filter table as one example of the image processing information table discussed with reference to FIGS. 10A-10C. The frame number identifies the frame to which the filtering process identified by the filter ID is applied.

Also in step S61, the system controller 18 writes the effect ID contained in the effect information of the image processing information and the frame number in association with each other in the effect table as one example of the image processing information table discussed with reference to FIGS. 10A-10C. The frame number identifies the frame to which the effect identified by the effect ID is applied.

The image processing information such as one of the effect ID and the filter ID is thus transferred to the compression controller 16.

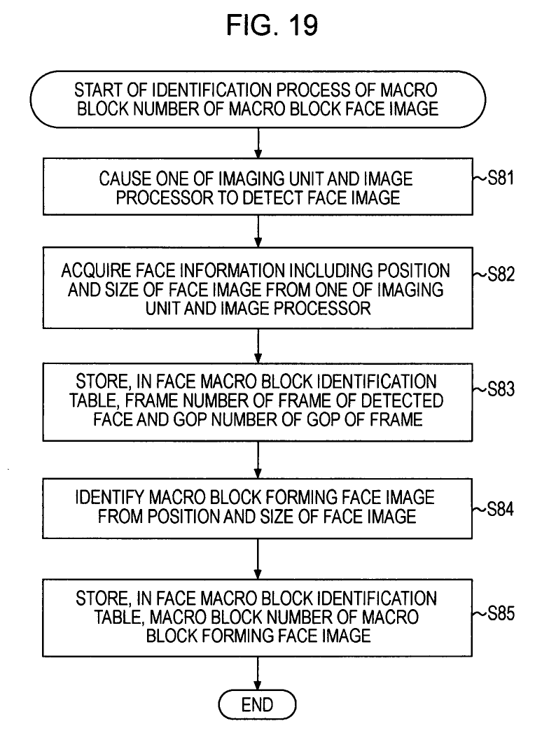

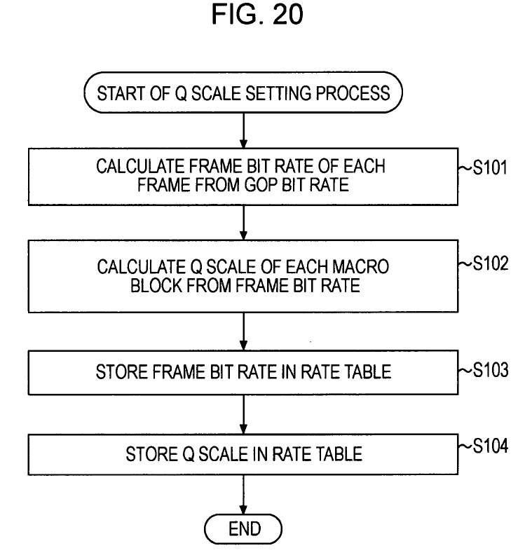

FIG. 19 is a flowchart illustrating an identification process of a macro block number of a macro block of a face image. In step S81, the system controller 18 causes one of the imaging unit 11 and the image processor 12 to detect a face image from the frame being photographed or being image processed.

In step S82, the system controller 18 acquires from one of the imaging unit 11 and the image processor 12 the position and the size of the face image. Step S82 corresponds to steps S12 and S13 of FIG. 15.

In step S82, the system controller 18 acquires the face information from one of the imaging unit 11 and the image processor 12 by inputting one of the imaging information containing the face information and the image processing information containing the face information. The size of the face image is determined by the height and the width or the size contained in the face information discussed with reference to FIG. 12.

In step S83, the system controller 18 stores in the face macro block identification table of the compression controller 16 the frame number of the frame from which the face image has been detected and the GOP number of the GOP of the frame. As previously discussed with reference to FIG. 12, the face information contains the frame number identifying the frame from which the face image has been detected. The system controller 18 stores in the face macro block identification table of the compression controller 16 the frame number contained in the face information and the GOP number of the GOP of the frame identified by the frame number in association with each other.

In step S84, the system controller 18 identifies the macro block forming the face image in the frame from which the face image has been detected, from the position and the size of the face image contained in the face information. For example, the position contained in the face information indicates the upper left corner of the face image of the frame by pixels, and the height and width indicate the height and width of the face image by pixels. Based on the height and width of the macro block represented by pixels, the system controller 18 identifies the macro block forming the face image in the frame.

In step S85, the system controller 18 stores in the face macro block identification table of the compression controller 16 the macro block number of the macro block forming the face image. Processing thus ends. More specifically, in step S85, the system controller 18 stores, in the face macro block identification table having the GOP number and the frame number stored in step S83, the macro block number of the macro block forming the face image.

The face macro block identification table of the compression controller 16 thus stores the macro block number identifying the macro block forming the fame image.

A Q scale setting process to the rate table of the compression controller 16 is described below with reference to a flowchart of FIG. 20. In step S101, the compression controller 16 calculates the frame bit rate of each frame belonging to the GOP having the GOP bit rate set therein, from the GOP bit rate set in the rate table. For example, in step S101, the compression controller 16 calculates the frame bit rate of each frame from the GOP bit rate depending on the picture type of the frame.

In step S102, the compression controller 16 calculates the Q scale of each macro block of the frame based the frame bit rate calculated in step S101.

In step S103, the compression controller 16 stores in the rate table the frame bit rate calculated in step S101 with the frame number identifying the frame in association therewith. In step S104, the compression controller 16 stores in the rate table the Q scale calculated in step S102 with the macro block number identifying the macro block in association therewith.

Through the Q scale setting process, a standard frame bit rate and the Q scale are calculated from the GOP bit rate and then stored in the rate table.

The Q scale thus calculated is corrected based on the imaging information or the image processing information contained in the rate control information.

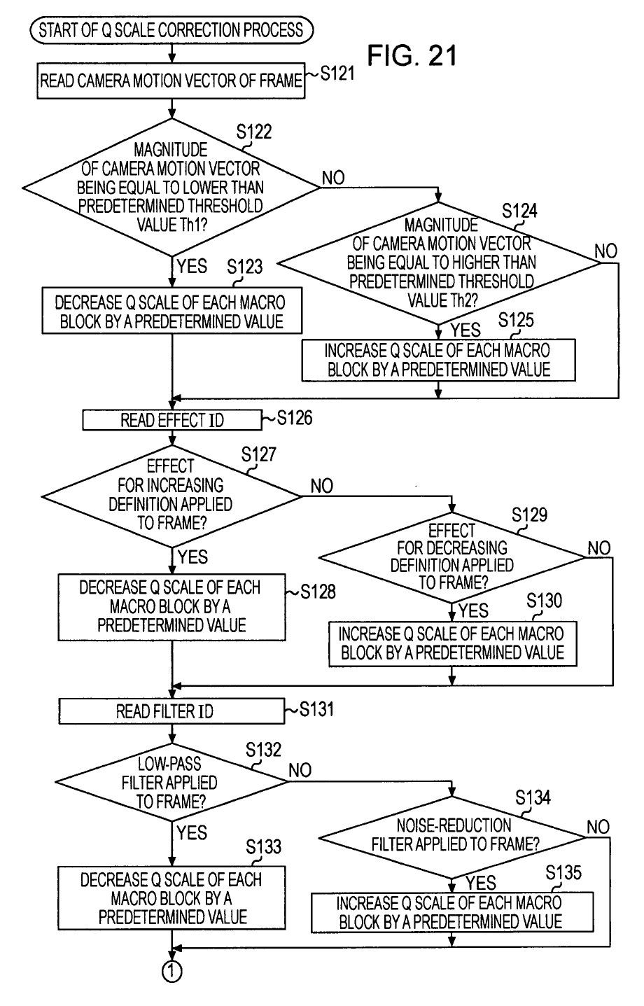

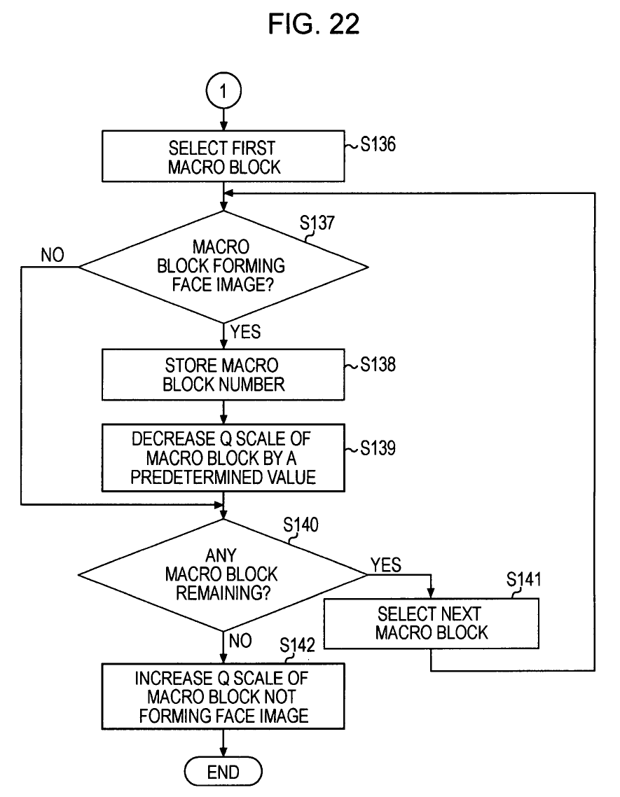

A Q scale correction process of the Q scale for each frame to be stored in the rate table is described below with reference to flowcharts of FIGS. 21 and 22. In step S121, the compression controller 16 reads the camera motion vector of the frame to be processed from the motion vector table as one example of the imaging information table. More specifically, the compression controller 16 reads from the vector table the camera motion vector arranged in association with the frame number identifying the target frame. In step S122, the compression controller 16 determines whether the magnitude of the camera motion vector is equal to or lower than a predetermined threshold value Th1. If it is determined in step S122 that the magnitude of the camera motion vector is equal to or lower than a predetermined threshold value Th1, a zooming operation or a panning operation is smoothly performed to keep track of a subject, and a user presumably desires to record an image at a high quality. Processing proceeds to step S123. The compression controller 16 decreases the Q scale of each macro block stored in the rate table by a predetermined value. Processing proceeds to step S126. In step S123, an amount of code of the target frame is increased to reproduce a high-quality image.

If it is determined in step S122 that the magnitude of the camera motion vector is not lower than the predetermined threshold value Th1, processing proceeds to step S124. The compression controller 16 determines whether the magnitude of the camera motion vector is equal to or higher than a predetermined threshold value Th2. The predetermined threshold value Th2 is a value higher than the predetermined threshold value Th1. If it is determined in step S124 that the magnitude of the camera motion vector is equal to or higher than a predetermined threshold value Th2, an angular velocity of the imaging unit 11 is large and no high-quality image is not being photographed. Processing proceeds to step S125. The compression controller 16 increases the Q scale of each macro block stored in the rate table by a predetermined value, and proceeds to step S126. In step S125, the image quality is restricted to a low level with a smaller amount of code involved in the target frame.

If it is determined in step S124 that the magnitude of the camera motion vector is not higher than the predetermined threshold value Th2, it is not necessary to modify the image quality and the amount of code. More specifically, the modification of the Q scale is not necessary. Processing proceeds to step S126 without modifying the Q scale.

In step S126, the compression controller 16 reads from the effect table as one example of the image processing information table the effect ID identifying the effect applied to the target frame. More specifically, the compression controller 16 reads from the effect table the effect ID stored in association with the frame number identifying the target frame.

In step S127, the compression controller 16 determines from the read effect ID whether the effect for increasing the definition of the image has been applied to the target frame. If it is determined in step S127 that the effect for increasing the definition of the image has been applied to the target frame, processing proceeds to step S128. The compression controller 16 decreases the Q scale of each macro block stored in the rate table by a predetermined value and then proceeds to step S131.

If it is determined in step S127 that the effect increasing the definition has not been applied to the frame, processing proceeds to step S129. The compression controller 16 determines from the read effect ID whether the effect for decreasing the definition has been applied to the target frame. If it is determined in step S129 that the effect for decreasing the definition has been applied to the target frame, processing proceeds to step S130. The compression controller 16 increases the Q scale of each macro block stored in the rate table by a predetermined value, and then proceeds to step S131.

If it is determined in step S129 that the effect for decreasing the definition has not been applied to the target frame, it is not necessary to modify the image quality and the amount of code. Since the modification of the Q scale is not necessary, processing proceeds to step S131 without modifying the Q scale.

In step S131, the compression controller 16 reads from the filter table as one example of the image processing information table the filter ID identifying the filtering process applied to the target frame. More specifically, the compression controller 16 reads the filter ID stored in association with the frame number identifying the target frame.

In step S132, the compression controller 16 determines from the read filter ID whether the low-pass filter has been applied to the target frame. If it is determined in step S132 that the low-pass filter has been applied to the target frame, processing proceeds to step S133. The compression controller 16 decreases the Q scale of each macro block stored in the rate table by a predetermined value, and then proceeds to step S136.

For example, if a complex and fine pattern is panned, the image processor 12 applies the low-pass filter to the frame to restrict the amount of data of the frame. It is considered that a high definition is required in such a frame, the Q scale is decreased. As a result, the amount of code is increased so that a high-quality image is reproduced from the target frame.

If it is determined in step S132 from the read filter ID that a sharp filter has been applied to the frame, the compression controller 16 may decrease in step S133 the Q scale of each macro block stored in the rate table by a predetermined value so that the target frame may be reproduced at a higher image definition.

If it is determined in step S132 that the low-pass filter has not been applied to the frame, processing proceeds to step S134. The compression controller 16 determines from the read filter ID whether a noise-reduction filter has been applied to the target frame. If it is determined in step S134 that the noise-reduction filter has been applied to the target frame, processing proceeds to step S135 to make a noise component less pronounced. The compression controller 16 increases the Q scale of each macro block stored in the rate table by a predetermined value. The image definition of the target frame is restricted and the amount of code is decreased. Processing proceeds to step S136.

If it is determined in step S134 that a soft-focus filter has been applied to the target frame, the definition of the frame is lowered by the soft-focus filter. Even if the amount of code is reduced, a change in the image definition of the frame to be reproduced from the code is difficult to recognize. In step S135, the compression controller 16 may increase the Q scale of each macro block stored in the rate table by a predetermined value.

If it is determined in step S134 that the noise-reduction filter has not been applied to the frame, it is not necessary to modify the Q scale. Processing proceeds to step S136 without modifying the Q scale.

In step S136, the compression controller 16 selects a first macro block from the target frame.

In step S137, the compression controller 16 determines whether the selected macro block is a macro block forming the face image. More specifically, the compression controller 16 searches the face macro block identification table for the macro block number identifying the selected macro block. If the macro block number is stored in the face macro block identification table, the compression controller 16 determines that the selected macro block is the one forming the face image. If the macro block number is not stored in the face macro block identification table, the compression controller 16 determines that the selected macro block is not the one forming the face image.

If it is determined in step S137 that the selected macro block is the one forming the face image, processing proceeds to step S138. The compression controller 16 stores the macro block number identifying the selected macro block. In step S139, the compression controller 16 decreases the Q scale of that macro block from among the other macro blocks by a predetermined value and then proceeds to step S140.

In other words, in step S139, the compression controller 16 decreases the Q scale arranged in association with the macro block number in the rate table identifying the selected macro block by a predetermined value.

The amount of code of the macro block forming the face image is increased so that a higher quality image is reproduced.

If it is determined in step S137 that the selected macro block is not the one forming the face image, processing proceeds to step S140 with steps S138 and S139 skipped.

In step S140, the compression controller 16 determines whether any target frame still remains, i.e., whether the target frame still includes any macro block that is yet to be determined as to whether the macro block forms the face image. If it is determined in step S140 that the target frame still includes a remaining macro block, processing proceeds to step S141. The compression controller 16 selects a next macro block from among the remaining macro blocks, and returns to step S137 to repeat step S137 and subsequent steps.

If it is determined in step S140 that the target frame has no remaining macro block, the compression controller 16 increases the Q scale of the macro block not forming the face image based on the macro block number stored in step S138, and then processing ends. More specifically, the compression controller 16 increases the Q scale stored in the rate scale in association with the macro block number other than the stored macro block numbers by a predetermined value.

In this way, the Q scale stored in the rate table is modified based on one of the imaging information supplied from the imaging unit 11 and the image processing information supplied from the image processor 12. In other words, the Q scale is modified so that the amount of code is increased in the frame or the macro block where a high definition or a high image quality is required and so that the amount of code is decreased in the frame or the macro block where a high definition or a high image quality is not required.

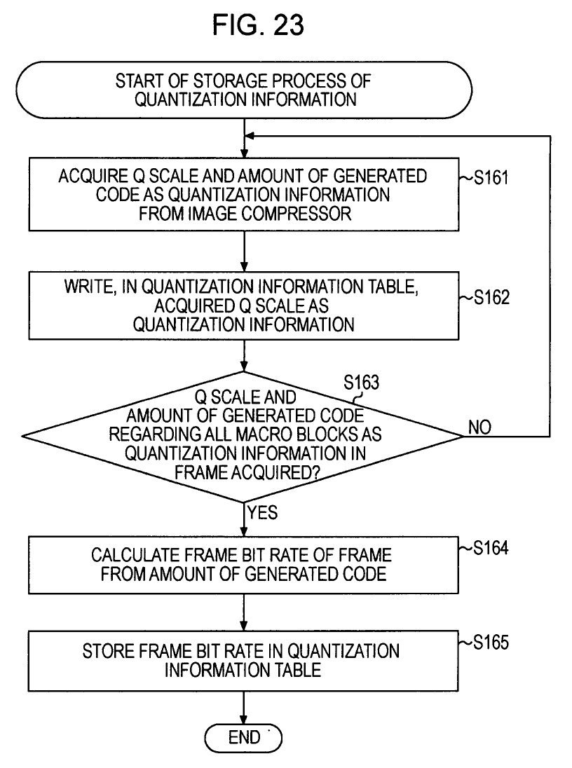

A storage process of the quantization information by the compression controller 16 is described below with reference to a flowchart of FIG. 23. In step S161, the compression controller 16 acquires from the image compressor 13 the Q scale used in the quantization of the macro block and the quantization information as the amount of generated code. In step S162, the compression controller 16 writes the quantization information as the acquired Q scale in the quantization information table. In this case, the quantization information as the Q scale is written in the table listing the Q scale from among the quantization information tables, namely, the table listing the frame number identifying the frame containing the macro block quantized in accordance with the acquired Q scale. In that table, the Q scale is written in association with the macro block number identifying the macro block quantized in accordance with the acquired Q scale.

In step S163, the compression controller 16 determines from the Q scale stored in the quantization information table whether the Q scale used in the quantization and the quantization information as the amount of generated code are acquired from all macro blocks of the frame. If it is determined in step S163 that the Q scale used in the quantization and the quantization information as the amount of generated code are not acquired from all macro blocks of the frame, processing returns to step S161. The above process is repeated until the Q scale used in the quantization and the quantization information as the amount of generated code are acquired from all macro blocks of the frame.

If it is determined in step S163 that the Q scale used in the quantization and the quantization information as the amount of generated code are acquired from all macro blocks of the frame, processing returns to step S164. The compression controller 16 calculates, from the amount of generated code of all macro blocks, the bit rate of the frame containing the macro block quantized in accordance with the acquired Q scale.

In step S165, the compression controller 16 stores the bit rate calculated in step S164 into the table listing the frame bit rate from among the quantization information tables in a manner such that the bit rate is in association with the frame number identifying the frame containing the macro block quantized in accordance with the acquired Q scale.

In this way, the Q scale used in the quantization and the bit rate of the frame are listed in the quantization information table.

FIG. 24 is a flowchart illustrating a rate instruction process of the compression controller 16 to the image compressor 13. In step S181, the compression controller 16 acquires from a counter indicating a GOP number, a frame number and a macro block number respectively identifying a GOP, a frame, and a macro block to be encoded by the image compressor 13. The counter may be arranged in one of the system controller 18, the compression controller 16 and the image compressor 13.

In step S182, the compression controller 16 reads the Q scale of the GOP number, the frame number and the macro block number identified by the count.

In step S183, the compression controller 16 supplies the read Q scale as the quantization instruction information to the image compressor 13 and then returns to step S181 to repeat step S181 and subsequent steps.

The Q scale of the macro block listed as the quantization instruction information in the rate table is thus supplied to the image compressor 13 that is going to encode the predetermined macro block.

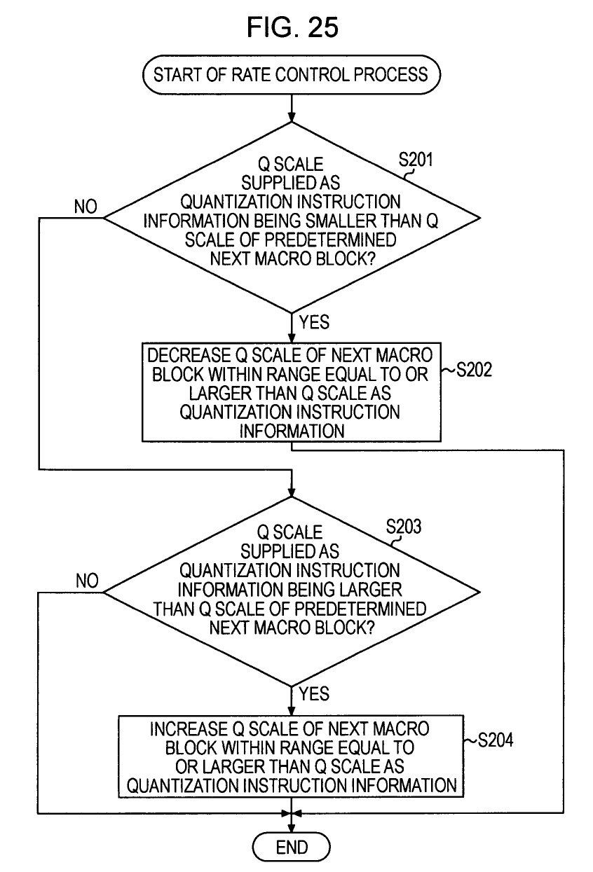

FIG. 25 is a flowchart illustrating a rate control process of the quantization controller 99 in the image compressor 13. In step S201, the quantization controller 99 compares the Q scale of a next macro block predetermined from the amount of code stored on the buffer 98 with the Q scale supplied from the compression controller 16 as the quantization instruction information. The quantization controller 99 thus determines whether the Q scale supplied from the compression controller 16 as the quantization instruction information is smaller than the Q scale determined as the next one.

If it is determined in step S201 that the Q scale supplied from the compression controller 16 as the quantization instruction information is smaller than the next Q scale, processing proceeds to step S202. The quantization controller 99 decreases the Q scale of the next macro block to within a range equal to or greater than the Q scale supplied from the compression controller 16 as the quantization instruction information by a predetermined value. Processing thus ends.

In step S202, the quantization controller 99 decreases the Q scale of the next macro block to satisfy conditions of a virtual buffer in consideration of the amount of code stored on the buffer 98. More specifically, the quantization controller 99 decreases the Q scale of the next macro block by subtracting a predetermined value by a predetermined number of times from the Q scale of the predetermined next macro block to within a range equal to or greater than the Q scale supplied from the compression controller 16 as the quantization instruction information.

If it is determined in step S201 that the Q scale supplied from the compression controller 16 as the quantization instruction information is not smaller than the Q scale of the predetermined next macro block, processing proceeds to step S203.

In step S203, the quantization controller 99 compares the Q scale of the next macro block determined from the amount code stored on the buffer 98 with the Q scale supplied from the compression controller 16 as the quantization instruction information. The quantization controller 99 thus determines whether the Q scale supplied from the compression controller 16 as the quantization instruction information is larger than the Q scale of the predetermined next macro block.

If it is determined in step S203 that the Q scale supplied from the compression controller 16 as the quantization instruction information is larger the Q scale of the predetermined next macro block, processing proceeds to step S204. The quantization controller 99 increases the Q scale of the next macro block to within the range equal to or lower than the Q scale supplied from the compression controller 16 as the quantization instruction information. Processing thus ends.

In step S204, the quantization controller 99 increases the Q scale of the next macro block to satisfy conditions of a virtual buffer in consideration of the amount of code stored on the buffer 98. More specifically, the quantization controller 99 increases the Q scale of the next macro block by adding a predetermined value by a predetermined number of times to the Q scale of the predetermined next macro block to within a range equal to or greater than the Q scale supplied from the compression controller 16 as the quantization instruction information.

If it is determined in step S203 that the Q scale supplied from the compression controller 16 as the quantization instruction information is not larger than the Q scale of the predetermined next macro block, the Q scale of the predetermined next macro block equals the Q scale as the quantization instruction information. Processing thus ends with step S204 skipped.

The quantization controller 99 controls the amount of code obtained from encoding the macro block by modifying the Q scale of the next macro block to become close to the Q scale supplied from the compression controller 16 as the quantization instruction information.

The pre-processor 81 in the image compressor 13 is freed from extracting the feature of the image to adjust the amount of code. As a result, a large capacity memory for storing the video data is not required. The image can be encoded in view of the image.

The moving image can also be encoded. The moving image may be generated or processed. One of the generated image and the processed image is encoded. The encoding of the moving image is controlled so that the amount of code per predetermined unit encoded by the encoding unit corresponds to the information supplied from the processing unit, the information indicating one of the status of the moving image, the status of generation of the moving image, and a process applied to the moving image. The image is thus encoded without the need for a large capacity memory.

The present invention is applicable to an apparatus for encoding a moving image, such as a hard disk drive recorder, a digital versatile disk (DVD) recorder or a cellular phone.

The quantization instruction information may be information for issuing an instruction to increase or decrease the amount of code.

The compression controller 16 calculates and stores beforehand the quantization instruction information in response to a unit of encoding, and then supplies the stored quantization instruction information. Alternatively, the compression controller 16 may calculate the quantization instruction information at the moment of supplying the information.

The above-referenced series of process steps may be performed using hardware or software. If the process steps are performed using software, a program of the software may be installed from a recording medium onto a computer built in dedicated hardware or a general-purpose personal computer enabled to perform a variety of functions with a variety of programs installed thereon.

As shown in FIG. 1, a recording medium records the program installed and executed on the computer. The recording media include the removable medium 21 as a package medium, such as one of a magnetic disk (including a flexible disk), an optical disk (such as compact disk read-only memory (CD-ROM)), or digital versatile disk (DVD)), and a semiconductor memory. The recording media also include a ROM or a hard disk, each permanently or temporarily storing the program, and contained one of the imaging unit 11, the image compressor 13, the compression controller 16 and the system controller 18. The storage of the program onto the program recording medium may be performed via a wired communication medium or a wireless communication medium using a communication interface (not shown) including a router or a modem, and a local area network, the Internet, or a digital broadcasting satellite.

The process steps describing the program stored on the recording medium may be performed in the time-series order sequence as previously stated. Alternatively, the process steps may be performed in parallel or separately.

It should be understood by those skilled in the art that various modifications, combinations, sub-combinations and alterations may occur depending on design requirements and other factors insofar as they are within the scope of the appended claims or the equivalents thereof.

What is claimed is:

1. An encoding apparatus comprising: processing means for generating and/or processing a moving image;
encoding means for encoding one of the generated moving image and the processed moving image; and
control means for controlling the encoding means so that an amount of code per predetermined unit encoded by the encoding means corresponds to information supplied from the processing means, the information indicating one of the status of the moving image, the status of generation of the moving image, and a process of the processing means applied to the moving image.

2. The encoding apparatus according to claim 1, wherein the control means controls the encoding means so that the amount of code per predetermined unit corresponds to the information supplied from the processing means, the information indicating one of the status of a frame forming the moving image, the status of generation of the frame, and the process applied to the frame.

3. The encoding apparatus according to claim 1, wherein the control means controls the encoding means so that the amount of code per encoding unit area corresponds to the information, the encoding unit area including a predetermined number of pixels in a frame forming the moving image.

4. The encoding apparatus according to claim 3, wherein the control means controls the encoding means so that an amount of code per macro block corresponds to the information by introducing a Q scale in the encoding of the macro block as the encoding unit area.

5. The encoding apparatus according to claim 1, further comprising introducing means for introducing an amount of code per group of pictures (GOP) in response to the information indicating one of the status of the moving image, the status of generation of the moving image, and the process applied to the moving image,
wherein the control means controls the encoding means so that an amount of code per macro block varies in response to the information with respect to the amount of code per introduced GOP, the macro block being the unit.

6. The encoding apparatus according to claim 1, wherein the control means controls the encoding means so that the amount of code per unit to be encoded by the encoding means from now on corresponds to the information and the amount of code encoded so far by the encoding means.

7. The encoding apparatus according to claim 1, wherein the processing means generates the moving image by photographing a subject.

8. The encoding apparatus according to claim 1, wherein the processing means processes the moving image to detect an image of a face contained in the moving image, and
wherein the control means controls the encoding means so that the amount of code per unit corresponds to the image of the detected face.

9. An encoding method of an encoding apparatus including a processing unit for generating and/or processing a moving image and an encoding unit for encoding one of the generated moving image and the processed moving image, the encoding method comprising a step of controlling the encoding unit so that an amount of code per predetermined unit encoded by the encoding unit corresponds to information supplied from the processing unit, the information indicating one of the status of the moving image, the status of generation of the moving image, and a process of the processing unit applied to the moving image.

10. A computer program for causing a computer to perform an encoding method of an encoding apparatus including a processing unit for generating and/or processing a moving image and an encoding unit for encoding one of the generated moving image and the processed moving image, the computer program comprising a step of controlling the encoding unit so that an amount of code per predetermined unit encoded by the encoding unit corresponds to information supplied from the processing unit, the information indicating one of the status of the moving image, the status of generation of the moving image, and a process of the processing unit applied to the moving image.

11. An encoding apparatus comprising:
a processing unit generating and/or processing a moving image;
an encoding unit encoding one of the generated moving image and the processed moving image; and
a control unit controlling the encoding unit so that an amount of code per predetermined unit encoded by the encoding unit corresponds to information supplied from the processing unit, the information indicating one of the status of the moving image, the status of generation of the moving image, and a process of the processing unit applied to the moving image.
